(19) United States
(12) Patent Application Publication
(10) Pub. No.: US 2007/0184411 A1
(43) Pub. Date: Aug. 9, 2007

(54) Method for producing a quantitative measure of dental health

(76) Inventor: Francis J. Stapleton, Pleasantville, NY (US)

Correspondence Address: MILDE & HOFFBERG, LLP, 10 BANK STREET, SUITE 460, WHITE PLAINS, NY, 10606, US

(21) Appl. No.: 11/633,783

(22) Filed: Dec. 5, 2006

Related U.S. Application Data
(60) Provisional application No. 60/771,817, filed on Feb. 9, 2006.

(51) Int. Cl. A61C 5/00

(52) U.S. Cl. 433/215

(57) ABSTRACT

An essentially three-step method is described for producing a quantitative measure of a patient's dental health. The method includes the following steps:

(1) Examining the teeth of the patient and obtaining a Decay, Missing and Filled Teeth (DMFT) score for the patient;
(2) Examining the supporting dental tissue of the patient and obtaining a Periodontal Screening and Recording (PSR) score or, alternatively, a periodontal score in accordance with the American Academy of Periodontology system of classification; and
(3) Producing an overall score of the dental health of the patient in dependence upon both the DMFT score and the PSR score.

### BACKGROUND OF THE INVENTION

The present invention relates to a method for examining a dental patient and producing a quantitative measure of the patient's dental health.

When a patient first visits a dentist, either for a check-up or a more serious dental issue, the dentist will normally conduct a full examination to gain an understanding of the patient's overall dental health as well as the patient's particular dental problem(s), if any. Because of the complexity and diversity of dental issues, and because of the numerous teeth involved, it is difficult for the dentist to communicate, except in a most general and superficial way, how the patient's teeth and gums appear and how they compare, statistically, to those of other patients of similar age, sex, geographical region, etc. While specific, treatable problems may be addressed and communicated, there is no standard by which the general dental health of a patient may be measured in a quantitative way so that the patient may be given a score, within a range of numbers, for example, from one to ten, one to twenty, or one to one hundred, that clearly informs the patient of his or her level of dental health, from very poor to very good or excellent.

Many methods and devices are known for diagnosing dental disease. Examples of such devices are X-ray machine and the numerous and varied dental tools for examining a patient's teeth and supporting tissues, such as examination probes of all types.

However, there is little or no literature that teaches or suggests a systematic method for determining the overall dental health of a patient which results in a quantitative, rather than a merely qualitative, measure.

In evaluating a patient's dental health, a clear distinction must be made between the patient's teeth and the supporting dental tissues which surround the teeth—for example, gum and bone. These two types of tissues are subject to completely different types of dental disease and require different techniques and types of evaluation. For example, examination of the teeth must necessarily be concerned with tooth decay, while periodontal disease is the chief concern of the supporting tissue. Any quantitative measure of overall dental health must take into consideration both of these diverse aspects of dental health.

Methods for producing a quantitative “score” for dental tissue have been used to analyze the effect of variables, such as the use of a fluoride, on the dental health of particular populations. See, for example, the research article, “The Distribution of Burden of Dental Caries in Schoolchildren: A Critique of the High Risk Caries Prevention Strategy for Populations” by P. Batchelor and A. Sheiham, BMC Oral Health, 2006, 6:3, Jan. 31, 2006. This article reports the effect of water fluoridation and the use of fissure sealants on the hard dental tissue of large groups of children. This study was based on data from the National Preventive Dentistry Demonstration Program (NPDDP) in the United States which used standardized DMF (decay, missing, filled) criteria of measurement. This technique produces a so-called “DMF-S Score” which ranges from 1 to 10, with 1 being the highest possible score. See also “Assessment of DMFT and Enamel Hypoplasia Among Junior High School Children in Iran”, A. R. Daneshkazemi and A. Davari, The Journal of Contemporary Dental Practice, Vol. 8, No. 4, Nov. 15, 2005, which reported a study based on the “DMFT index” or score.

It is known also to produce a quantitative measure-of-periodontal disease using a standardized scoring method known as “Periodontal Screening and Recording” (PSR). With this system, a periodontal examination probe is inserted into the gingival sulcus of each tooth until light resistance is met when “walking” the probe around the tooth's circumference. The greatest probe depth in each sextant of the mouth is determined and recorded. Each sextant is then assigned a code based on the highest probing value obtained on any tooth in that sextant. The PSR codes range from zero (highest score) to four (lowest score). See, for example, the article “The Application of Periodontal Screening and Recording (PSR) in a Military Population” by L. Covington, L. Breault and S. Hokett, The Journal of Contemporary Dental Practice, Vol. 4, No. 3, Aug. 13, 2003.

In 1989 The American Academy of Periodontology announced a new classification system for periodontal diseases, wherein the seriousness of a patient's disease was classified into Type I, Type II, Type III and Type IV, with Type IV being the most serious. See Proceedings of the World Workshop in Clinical Periodontics, The American Academy of Periodontology; 1989: 1/23-1-24. This classification found worldwide acceptance and has been updated several times. See Changes in the Classification System for Periodontal Diseases, by Gary C. Armitage, Ann Periodontol 1996; 1:37-215 and 1999; 4:1-6.

Some attempts have already been made to evaluate the overall dental health of patients with an eye to developing a workable scoring system. One such system is discussed in the article “Evaluation of an Oral Health Scoring System by Dentists in General Dental Practice” by M. Busby, S. McHugh, S. Delargy, A. Mullins and R. Matthews, British Dental Journal, Vol. 194, No. 4, Feb. 22, 2003. However this oral health score (OHS) was based upon a general dental examination which assessed qualitatively the following criteria:

Patient's perception of comfort and aesthetics,

Caries and screening caries,

General “wear and tear”,

Periodontics,

Occlusions, and

Mucosa.

Subjective scores were given to each criterion in the range of 1 to 24 by the examining dentist and these scores were weighted, to account for the perceived relative “importance” of each criterion, and then added together to produce a total score.

Because of its complexity, this scoring system is difficult to follow and to administer in practice. It also is highly dependent upon the subjective assessments of the dental practitioners.

### SUMMARY OF THE INVENTION

It is therefore a principal object of the present invention to provide a method for assessing a patient's overall dental health in a quantitative way, so as to provide a basis for communication with the patient and to create a dental health record against which future improvements may be measured.

It is a further object of the present invention to provide a method for producing a quantitative measure of the dental health of a plurality of patients to form the basis for reliable statistics from which to assess the effects of a variety of variables such as fluoridation, nutrition, environment, etc.

These objects, as well as further objects which will become apparent from the discussion that follows, are achieved, in accordance with the present invention, by carrying out an essentially three-step method of, which includes the steps of:

(1) examining the teeth of the patient and obtaining a Decay, Missing and Filled Teeth (DMFT) score for the patient;

(2) examining the supporting dental tissue of the patient and obtaining a Periodontal Screening and Recording (PSR) score for the patient or, in the alternative, a periodontal score in accordance with the American Academy of Periodontology system of classification; and

(3) producing an overall score of the dental health of the patient in dependence upon both the DMFT score and the PSR score.

According to a preferred embodiment of the invention, a modified DMFT analysis is used for the examination of hard dental tissue. As noted above, the DMFT evaluation method is a well-known technique and has been used for many years to analyze the effects of variables, such as fluoride, on the dental health of given populations. For purposes of the present scoring system, the DMFT method is preferably modified slightly in that the wisdom teeth (third molars) are removed from consideration since third molar extraction is virtually the rule rather than the exception and, if not removed, the functionality of third molars makes little discernable contribution to enhancing a person's “dental quality of life.” Only in the case where a patient's second molars are missing, and the third molars are fully functioning in the second molars place, are the third molars included in the DMFT score.

In analyzing each tooth to produce a DMFT score, the critical crown of the tooth is divided into five surfaces. Additionally, the number of roots for a tooth typically ranges from one to three. For the purpose of this DMF analysis, each tooth is scored as having, on average, the value of two roots, or surfaces. Therefore, in this analysis, the DMFT score is based on a total of seven surfaces for each counted tooth of the patient, consisting of five crown surfaces and two root surfaces.

If a tooth has been extracted for orthodontic reasons, it is simply not counted when obtaining the DMFT score since such removal is aimed at improving the patient's dental health by aligning the patient's arches and teeth.

Similarly, the presence or absence of root canal therapy is not considered to be significant in the DMFT analysis, unless there is evidence of chronic recurring infection or some other negative factor associated with the root canal therapy. The DMFT score may be adjusted by either assuming that the tooth will survive after root canal treatment (or re-treatment), and then evaluating the restorative needs of that tooth, or by assuming that the tooth will fail and be extracted.

Implants with well-placed crown restorations are counted the same as virgin teeth with all its surfaces intact. Failing implants, or implants with poorly placed restorations, are considered in the same spirit as their natural counterparts.

Finally, properly made removable prosthetic appliances may be counted in the restoration of function. However, at best they may only return no more than one half of the possible value or score of the natural teeth that they replace. Furthermore, adjustment must frequently be made to reflect the condition of the prothesis; i.e., the wearing of occlusal surfaces, broken clasps and the like, result in downgrading the maximum score.

According to a further feature of the present invention, the total DMFT score of a patient is classified into one of a plurality of score groups, each with a different range of scores. This facilitates the dentist's communication with the patient since informing the patient of the score group or range of scores facilitates communication as compared to the raw DMFT score itself.

When examining the supporting dental tissue of the patient, either the PSR scoring system or the classification system of the American Academy of Periodontology is used to classify periodontal disease into one of five types: O, Type I, Type II, Type III and Type IV. For example, the PSR score is obtained by gently inserting a plastic PSR periodontal examination probe into the gingival sulcus of each tooth until light resistance is met and then “walking” the probe around the tooth's circumference, beginning in the maxillary right sextant, proceeding in a clockwise manner and finishing in the mandibular right sextant. Each sextant is assigned a code based on the highest probing value obtained on any tooth in that sextant. The codes range from zero to four plus code * and code x, from best to worst. It is assumed that dental patients with code * and code x are in need of immediate treatment and are therefore not included in the scoring system.

The periodontal score according to the classification system of the American Academy of Periodontology is obtained in the well-known manner prescribed by the Academy.

Once both a DMFT score group and a periodontal score are determined, by examining the patient's teeth and supporting dental tissue, respectively, these two scores are used to produce an overall quantitative score of the dental health of the patient. Preferably, this overall score, hereinafter called an “index number”, is in a range of numbers from one to twenty which gives an adequate quantitative measure of the patient's dental health consistent with the accuracy of the original scores. A coarser evaluation, say in the range of one to ten, would forfeit some fine grain detail, while a higher range of numbers, say from one to one hundred, would imply an apparent accuracy which is simply not available from the examination techniques.

Preferably also, the index number increases with the decreasing dental health of the patient, since with the periodontal diagnosis at least, the lowest class (zero) represents a perfect score whereas the higher classes, Type I, Type II, Type III and Type IV, represent progressively deteriorating dental health.

As the preferred embodiment, the index numbers are derived from the DMFT score and the periodotal score according to the following table:

### Periodontal Diagnosis (Periodontal Score)

| | | 0 | TYPE I | TYPE II | TYPE III | TYPE IV |
|---|---|---|---|---|---|---|
| % of | 100–86% | 1 | 2 | 7 | 13 | 17 |
| Intact | | | | | | |
| Healthy | 85–76% | 3 | 4 | 8 | 14 | 18 |
| Tooth | 75–51% | 5 | 6 | 9 | 15 | 19 |
| Surfaces | | | | | | |
| | 50–0% | 10 | 11 | 12 | 16 | 20 |

### BRIEF DESCRIPTION OF THE DRAWINGS

FIG. 1 is a tooth chart of a patient with a DMFT score in the range of 86-100%.

FIG. 2 is a tooth chart of a patient with a DMFT score in the range of 76-85%.

FIG. 3 is a tooth chart of a patient with a DMFT score in the range of 51-75%.

FIG. 4 is a tooth chart of a patient with a DMFT score in the range of 0-50%.

FIG. 5 is a diagram showing a periodontal examination probe of the type used in obtaining a PSR score.

FIG. 6 is a table of index numbers in the range of 1-20, derived from the DMFT score and the PSR score of a patient.

### DESCRIPTION OF THE PREFERRED EMBODIMENT

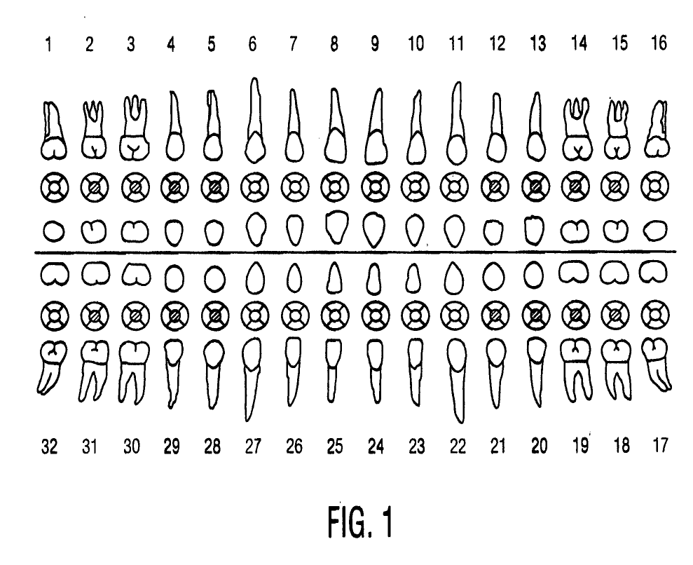

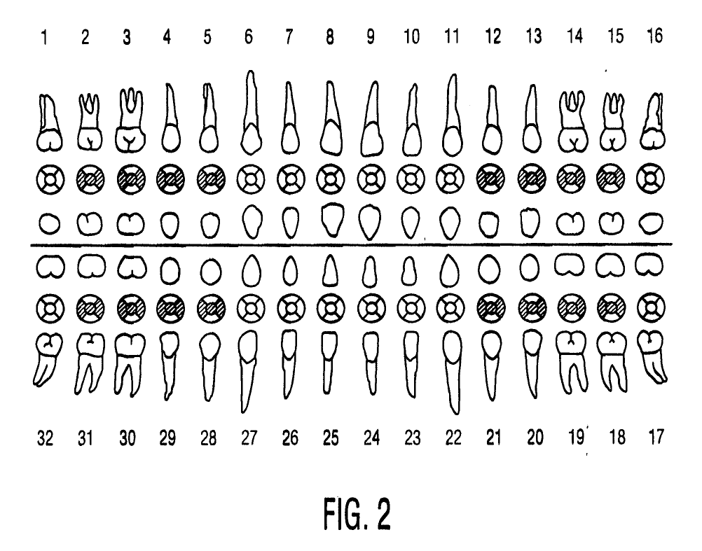

FIGS. 1-4 are exemplary tooth charts for four different (fictitious) patients with various degrees of tooth decay and missing teeth. These charts illustrate how the DMTF score is arrived at, according to the invention. Of the four dental patients represented in these charts, a first has excellent teeth (FIG. 1) whereas the second, third and fourth patients (FIGS. 2, 3 and 4) have successively poorer dental health.

Given seven surfaces per tooth, there are a total of 224 possible surfaces when evaluating 32 adult teeth. However, as noted above, the four wisdom teeth are excluded from consideration, leaving a total of 28 teeth or 196 surfaces. If all 196 surfaces were present and intact without need of repair, the patient would receive a perfect score. However, should any of these surfaces need repair, for example due to decay, the number of such surfaces is subtracted from the total. Should any surface have been repaired, even if the restoration present is in good repair, one point is subtracted for each such surface since this tooth is considered to be less than perfect. The reasoning for this is that any partial restoration of a tooth will eventually result in maintenance issues. The exception to this rule is that the restoration of a tooth with a full crown or “cast” restoration (irrespective of the material used) fully restores the tooth. This rule is based on the concept that a well placed, technically sound crown restarts the tooth health cycle, since it is generally expected that a clinically sound crown should last on the order of decades, rather than years, in a stable mouth.

In the chart of FIG. 1, tooth decay is indicated in the central portion only of four teeth in each quadrant. To obtain the DMTF score, the total number of points of decay, 16, is subtracted from the total possible score 196, giving this patient a DMTF score of 180 or 92% (180/196×100).

The chart of FIG. 2 shows that these same teeth in each quadrant have been further degraded by decay, with three out of the five crown surfaces of each tooth showing decay. In this example, therefore, the number 48 is subtracted from the total possible score 196, leaving a DMTF score of 148 or 76%.

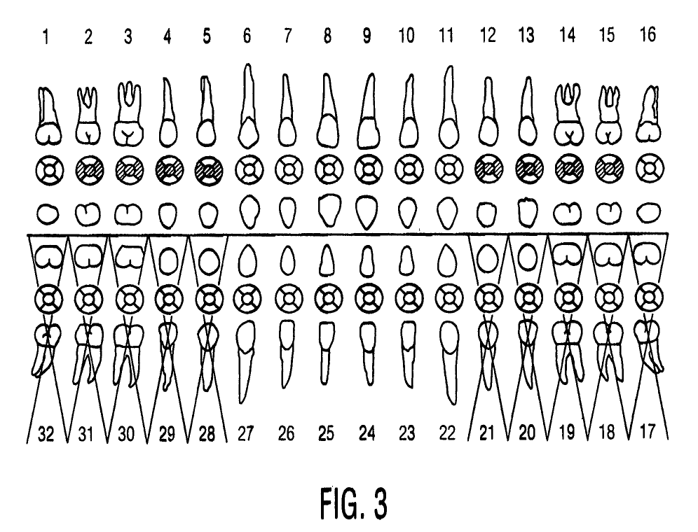

The fictitious dental patient with the chart of FIG. 3 has had five teeth in both the lower left and lower right quadrant completely removed, two of which are wisdom teeth. Assuming seven surfaces per tooth, the number 42 is subtracted from the total score 196, giving a preliminary score of 154. In addition, eight teeth in the upper left and upper right quadrant have less than perfect scores (two out of five) so that 24 is additionally subtracted from the score leaving a total score of 130. The final percentage is therefore 130/196×100 or 66%.

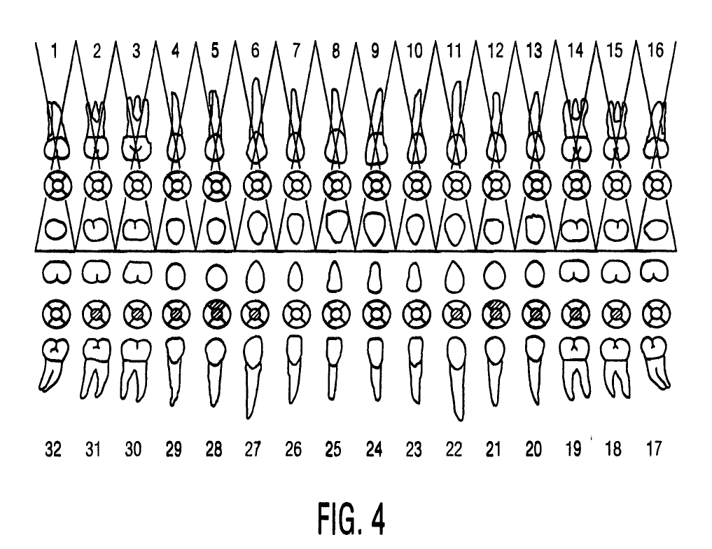

Finally, in the chart of FIG. 4, all of the patient's upper teeth, including two wisdom teeth, have been removed, so that a score of 14 (non-wisdom teeth) times 7 (surfaces) or a score of 98 is subtracted from the total score 196 leaving a DMFT score of 98. The additional 14 points of decay on the lower teeth reduce the score further to 84 or 43%.

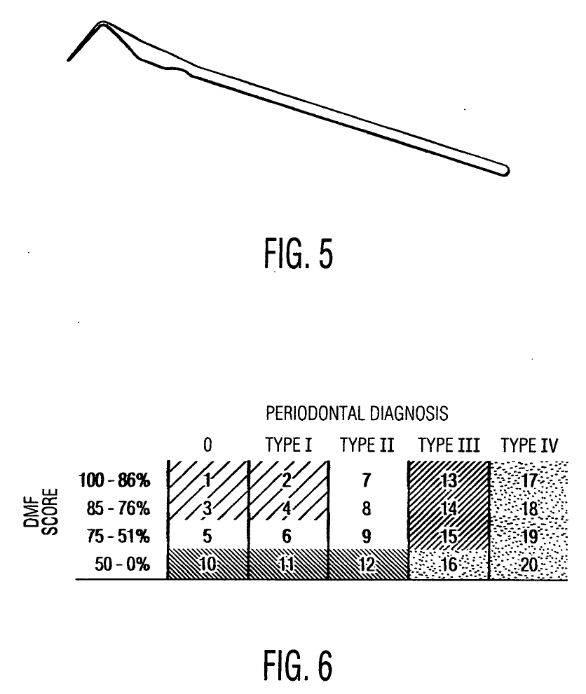

The periodontal score of a dental patient is obtained in the well-known manner for examining dental patients for periodontal disease. The PSR scoring system utilizes a periodontal examination probe of the type shown in FIG. 5. According to the invention, either the standard periodontal screening and recording (PSR) method or the classification system of the American Academy of Periodontology may used to derive a periodontal score falling into one of five “classes”: zero (0), Type I, Type II, Type III or Type IV.

FIG. 6 is a table showing how the final score or index number is derived from the DMFT score and the PSR score according to invention to provide a quantitative measure of the overall dental health of the patient. As may be seen, if the DMFT score is in the highest group (86%-100%) and the periodontal score is zero, the patient is awarded the lowest score: 1. Conversely, if the DMFT score is in the lowest group (0-50%) and the periodontal score indicates Type IV, the patient is given the highest overall score: 20. The index numbers, which thus range from one to twenty, are allocated in the manner indicated in the table in dependence upon both the DMFT and the periodontal scores.

Once the final, total score is arrived at for the dental patient, the patient may be informed of his or her score, and provided with a chart showing the statistical distribution of scores developed over time of other dental patients of similar age, sex, geographic location, etc. To provide such a chart, a data bank must be maintained in which the scores of numerous dental patients are collected in association with their demographics.

There has thus been shown and described a novel method for producing a quantitative measure of dental health which fulfills all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. A method for producing a quantitative measure of a patient's dental health, said method comprising the steps of:
(a) examining the teeth of the patient and obtaining a Decay, Missing and Filled Teeth (DMFT) score for the patient;
(b) examining the supporting dental tissue of the patient and obtaining a periodontal score for the patient; and
(c) producing an overall score of the dental health of the patient in dependence upon both the DMFT score and the periodontal score.

2. The method defined in claim 1, wherein the third molars of the patient are not considered in obtaining the DMFT score, unless they are fully functioning and the second molars are missing.

3. The method defined in claim 1, wherein the DMFT score is based on a total of seven surfaces for each counted tooth of the patient, consisting of five crown surfaces and two root surfaces.

4. The method defined in claim 1, wherein teeth extracted for orthodontic reasons are not counted when obtaining the DMFT score.

5. The method defined in claim 1, wherein a patient's tooth with root canal therapy is counted as a normal tooth in the DMFT score.

6. The method defined in claim 1, wherein a tooth supported on a dental implant is counted as a normal tooth in the DMFT score.

7. The method defined in claim 1, wherein the DMFT score is classified into one of a plurality of score groups, each with a different range of scores, and further comprising the step of determining the score group for the patient.

8. The method defined in claim 7, wherein the DMFT score is classified into percentage scores that are above and below about 50%.

9. The method defined in claim 8, wherein the DMFT score above 50% is classified into percentage scores that are above and below about 75%.

10. The method defined in claim 8, wherein the DMFT score above 75% is classified into percentage scores that are above and below about 85%.

11. The method defined in claim 1, wherein the periodontal score is obtained by determining the deepest probing depth in each intraoral sextant of the patient's teeth using a periodontal examination probe.

12. The method defined in claim 11, wherein the probing depth is classified into one of a plurality of codes, each representing a different range of depths.

13. The method defined in claim 1, wherein the periodontal score is obtained in accordance with the American Academy of Periodontology system of classification.

14. The method defined in claim 1, wherein the overall score is an index number based upon both the DMFT score and the periodontal score.

15. The method defined in claim 14, wherein the index number increases with decreasing dental health of the patient.

16. The method defined in claim 15, wherein index numbers in the range of 1 to 4 represent a relatively good dental health of the patient.

17. The method defined in claim 15, wherein index numbers in the range of 5 to 9 represent an at risk dental health of the patient.

18. The method defined in claim 15, wherein index numbers in the range of 10 to 15 represent relatively poor dental health of the patient.

19. The method defined in claim 15, wherein the index numbers are determined from the ranges of DMFT scores and PSR scores.

20. The method defined in claim 19, wherein the index numbers are determined from the following table:
PERIODONTAL DIAGNOSIS (PERIODONTAL SCORE)

| | 0 | TYPE 1 | TYPE II | TYPE III | TYPE IV |
|---|---|---|---|---|---|
| 100–86% | 1 | 2 | 7 | 13 | 17 |
| 85–76% | 3 | 4 | 8 | 14 | 18 |
| 75–51% | 5 | 6 | 9 | 15 | 19 |
| 50–0% | 10 | 11 | 12 | 16 | 20 |
